(19) United States
(12) Patent Application Publication
(10) Pub. No.: US 2017/0033480 A1
(43) Pub. Date: Feb. 2, 2017

(54) Connection Structure of Connector and Connector

(71) Applicant: IRISO ELECTRONICS CO., LTD., Yokohama-shi, Kanagawa (JP)

(72) Inventor: Katsumasa Sato, Yokohama-shi, Kanagawa (JP)

(73) Assignee: IRISO ELECTRONICS CO., LTD., Yokohama-shi, Kanagawa (JP)

(21) Appl. No.: 15/303,566

(22) PCT Filed: Jun. 23, 2015
(86) PCT No.: PCT/JP2015/068034

§ 371 Date: Oct. 12, 2016

(30) Foreign Application Priority Data
Jun. 23, 2014 (JP) 2014-128093

(51) Int. Cl. H01R 12/71; H01R 13/04

(52) U.S. Cl. CPC H01R 12/716; H01R 13/04

(57) ABSTRACT

A socket connector includes a housing mounted on a substrate, a plurality of socket terminals 6 that is held by the housing. The plurality of socket terminals is, on one end side thereof, conductively connected to a single connection pad provided in a circuit pattern of the substrate, and is, on the other end side thereof, conductively connected to a plug terminal that is to be a connection mate. Each of the socket terminals includes a substrate connection portion that is fixed to a connection pad, a contact portion that comes into conductive contact with a substrate, and a connection piece portion that connects the contact portion and the substrate connection portion to each other. The connection piece portion including a branched pieces forming conductive paths E that connect, in a parallel manner, the contact portion and the substrate connection portion splits an electric current in a parallel manner.

### TECHNICAL FIELD

The present invention relates to a connector and a connection structure of the connector, which is capable of managing a large electric current.

### BACKGROUND ART

Various electrical components and electronic equipment mounted in a vehicle operate by electric power from a battery and a control signal, and a wire harness is typically used to transmit the electric power and the signal. Furthermore, in order to adapt to the progress in car electronics technology of recent years, wire harnesses are required to be provided with advanced functions, and for example, one that is capable of managing a large electric current has been proposed (PTL 1, as an example).

### CITATION LIST

### Patent Literature

PTL 1: Japanese Unexamined Patent Application Publication No. 2009-123461

### SUMMARY OF INVENTION

### Technical Problem

However, in recent years, response towards further increase in electric current and high temperature resistance is in need for electric vehicles and hybrid cars. Furthermore, due to sophistication and complication of electrical components and electronic equipment mounted in a vehicle, the wire harnesses that are needed is increasing and a space for wiring the wires needs to be secured. Accordingly, wiring may, disadvantageously, become difficult or the vehicle weight may disadvantageously increase.

The present invention has been made while taking in account the background of the related art described above. An object thereof is to provide a small-sized connector capable of managing a large electric current different from the wire harness.

### Solution to Problem

In order to achieve the above object, the present invention is configured in the following manner.

In other words, the present invention provides a connection structure of a connector, including a first connector that conductively connects a connection object to a substrate, the first connector including a housing, and a plurality of terminals that are disposed so as to oppose each other, that hold the connection object in between, and that come into contact with the connection object. The plurality of terminals each include a substrate connection portion that comes into conductive contact with a common connection pad provided on the substrate, a contact portion that comes into conductive contact with the connection object, and a connection piece portion formed of a plurality of branched pieces connecting, in a parallel manner, each substrate connection portion and the corresponding contact portion.

Furthermore, the present invention provides a connector, including a housing mounted on a substrate, and a plurality of terminals held by the housing. Each of the terminals includes a substrate connection portion that conductively connects to a common connection pad provided on the substrate, a contact portion that comes into conductive contact with a common connection object that is a connection mate of the connector, and a connection piece portion formed of a plurality of branched pieces forming parallel conductive paths that connect each of the substrate connection portion and the corresponding contact portion to each other.

The present invention includes a plurality of terminals. In the terminals, substrate connection portions that conductively connect to a common connection pad provided on the substrate and contact portions that come into conductive contact with a common connection object that is a connection mate of the connector are connected in a parallel manner with a connection piece portion formed of a plurality of branched pieces. By so doing, firstly, an electric current can be split in a parallel manner to each of the terminals. Secondly, electric current can be split to each of the terminals in a parallel manner with the connection piece portion. Accordingly, in the connector and the connection structure of the present invention, the electric current can be split in a parallel manner at multiple stages and the resistance value can be lowered enabling the connector and the connection structure to manage a large electric current. Furthermore, by splitting the electric current in the above manner, even if the cross-sectional area of the branched piece that forms the connection piece portion, for example, is formed smaller than those of the other portions of the terminal, heat generation from the connection piece portion can be suppressed.

The plurality of terminals of the present invention may be disposed to oppose each other and be conductively connected with the connection object in between. With the above, conductive contact to the connection object can be made in a reliable manner.

Furthermore, for example, by having the plurality of terminals of the present invention to have the same shape and size with respect to each other, the values of the electric current flowing in each terminal can be equalized. With the above, heat quantity of each terminal can be equalized. Furthermore, by having the cross-sectional area of the branched pieces be the same and, for example, by forming the branched pieces to have the same shape and size, the values of the electric current values in the branched pieces can be equalized. With the above, the heat quantities of the branched pieces can be equalized such that a situation in which one of the branched pieces alone becomes high in temperature can be prevented. Furthermore, by having a plurality of terminals having the same size and shape, no portions of the terminals will be connected to each other; accordingly, compared with, for example, a terminal that is formed by bending a single metal piece and that has a plurality of contact portions, the structure is simple and manufacture thereof is facilitated, and the electric current can be split to each of the terminals in a reliable manner.

The contact portion of the present invention may include a plurality of branch contact portions that form parallel conductive paths. By so doing, since the electric current flowing through the contact portions can be split in a parallel manner to the plurality of branch contact portions and the resistance value can be lowered, the connector can be one in which management of a higher electric current is facilitated. Furthermore, by splitting the electric current, even if the cross-sectional area of the branch contact portion, for example, is formed smaller than those of the other portions of the terminal, heat generation from the contact portion can be suppressed.

The substrate connection portion of the present invention may include a plurality of branch substrate connection portions that form parallel conductive paths. By so doing, since the electric current flowing through the substrate connection portions can be split in a parallel manner to the plurality of branch substrate connection portions and the resistance value can be lowered, the connector can be one in which management of a higher electric current is facilitated. Furthermore, by splitting the electric current, for example, heat generation from the substrate connection portion can be suppressed.

The terminals of the present invention may include a first connection portion connected to the plurality of branch contact portions, and the first connection portion may include first fixing portions that fix the terminals to the housing. With the above, the terminals can, on the branch contact portion side, be fixed to the housing in a reliable manner.

The terminals of the present invention may include a second connection portion connected to the plurality of branched pieces, and the second connection portion may include second fixing portions that fix the terminals to the housing.

With the above, the terminals can, on the branch piece side, be fixed to the housing in a reliable manner.

The housing of the present invention may include a fixed housing and a movable housing relatively displaced with respect to the fixed housing. The substrate connection portion may be provided in the fixed housing, the contact portion may be provided in the movable housing, and the branched pieces of the connection piece portion may be movable pieces that support the movable housing in a relatively displaceable manner with respect to the fixed housing.

Since the branched pieces are movable pieces that supports the movable housing in a relatively displaceable manner with respect to the fixed housing, the connector may be one provided with a floating mechanism. With the above, for example, even in a case in which positional displacement occurs when the contact portion provided on the movable housing side and the connection object are fitted to each other and in a case in which the movable pieces applies vibration to the movable housing, the movable pieces relatively displacing the movable housing with respect to the fixed housing is capable of absorbing the positional displacement. Accordingly, the contact portion and the connection object can be in contact with each other in a reliable manner and a connector becomes high in connection reliability.

In the connector provided with the floating mechanism, typically, it is desirable that a movable piece of a single terminal is formed thin and narrow in a thin shaft shape in order to facilitate elastic deformation in a flexible manner. However, when formed thin and narrow in width, the cross-sectional area thereof becomes smaller and the electric resistance becomes larger. In such a case, when a large electric current is distributed, the movable piece generating heat becomes high in temperature, or in the worst case scenario, may become thermally cut. Conversely, when the cross-sectional area of the movable piece is increased to suppress heat generation, elastic deformation described above will be difficult and, further, it will be difficult to respond to the demand in miniaturization of the collector. When focusing on the movable piece, flexibility in the floating mechanism and managing of a large electric current become a demand evoking a conflict in the existing terminal structure.

Accordingly, different from the conventional terminal in which a single movable piece is provided in a single terminal, in the present invention, a plurality of branched pieces included in the connection piece portion are configured as movable pieces such that heat generation can be suppressed while both increase in the cross-sectional area so as to be capable of being used under a large electric current and flexibility of the movable pieces to manage the floating mechanism are achieved.

The housing of the present invention may accommodate the terminals therein and may include an opening portion that exposes the connection piece portion of the terminals externally. By so doing, the heat of the connection piece portion can be released to the outside and heat release can be facilitated.

The movable pieces of the present invention may each include an elongation portion that is elongated from the substrate connection portion, and a bent portion bent back from an end portion of the elongation portion, and the elongation portion may be formed such that a width on a substrate connection portion side is wider than a width of the bent portion. During fitting, when positional displacement occurs or when vibration is applied to the connector, pressure is applied to the terminals from the connection object. In such a case, in the terminals, there will be a load on the substrate connection portion fixed to the connection pad and on the movable pieces connected to the substrate connection portion. Accordingly, by forming the elongation portion so that the side on the substrate connection portion is wider than the bent portions, the branched pieces, to where the largest load is applied, can be made difficult to become damaged or deformed.

The plurality of terminals of the present invention may be disposed to oppose each other and be in conductive contact with the connection object in between. With the above, the connection object can be held in a reliable manner with the opposing terminals.

### Advantageous Effects of Invention

Since the plurality of conductive paths are formed in a parallel manner and the electric current can be split, the connector and the connection structure of the connector of the present invention are capable of managing a large electric current while reducing size.

### BRIEF DESCRIPTION OF DRAWINGS

FIG. 1 is a perspective view of a socket connector of a first embodiment.

FIG. 2 is an explanatory drawing illustrating a state in which the socket connector in FIG. 1 is installed on a substrate.

FIG. 3 is a front view of the socket connector in FIG. 1.

FIG. 4 is a right side view of the socket connector in FIG. 1.

FIG. 5 is a plan view of the socket connector in FIG. 1.

FIG. 6 is a bottom view of the socket connector in FIG. 1.

FIG. 7 is a perspective view of a socket terminal in FIG. 1.

FIG. 8 is a front view of the socket terminal in FIG. 1.

FIG. 9 is a rear view of the socket terminal in FIG. 1.

FIG. 10 is a right side view of the socket terminal in FIG. 1.

FIG. 11 is a plan view of the socket terminal in FIG. 1.

FIG. 12 is a bottom view of the socket terminal in FIG. 1.

FIG. 13 is a perspective view of a plug connector.

FIG. 14 is a perspective view illustrating a state in which the socket connector and the plug connector are fitted to each other.

FIG. 15 is a cross-sectional view taken along a line indicated by arrows SA-SA, and illustrates a state in which the socket connector and the plug connector in FIG. 14 are fixed to the substrate.

FIG. 16 is an explanatory drawing illustrating a state in which the socket terminal and a plug terminal are in contact with each other.

FIG. 17 is a perspective view of a socket connector of a second embodiment.

FIG. 18 is a perspective view of a socket terminal in FIG. 17.

FIG. 19 is a front view of the socket terminal in FIG. 17.

FIG. 20 is a rear view of the socket terminal in FIG. 17.

FIG. 21 is a right side view of the socket terminal in FIG. 17.

FIG. 22 is a plan view of the socket terminal in FIG. 17.

FIG. 23 is a bottom view of the socket terminal in FIG. 17.

### DESCRIPTION OF EMBODIMENTS

Hereinafter, embodiments of the present invention will be described with reference to the drawings. Components that are common among each embodiment will be attached with the same reference numerals and redundant description thereof will be omitted.

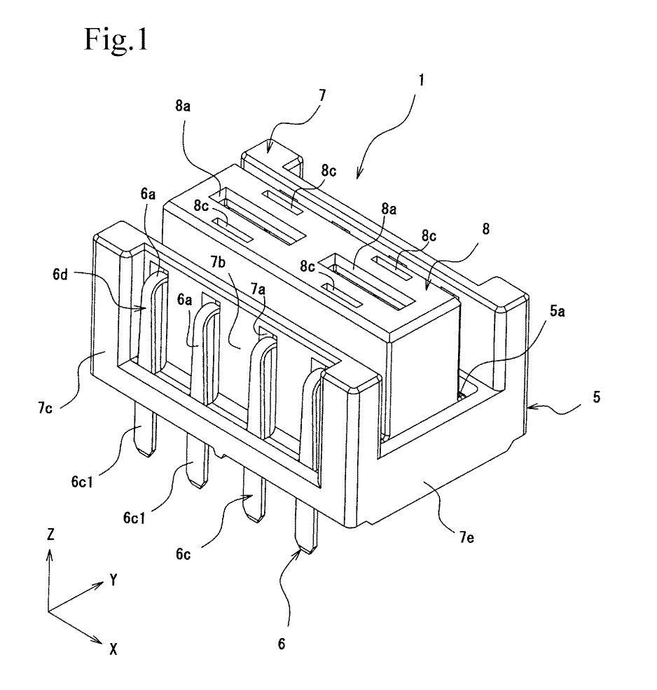

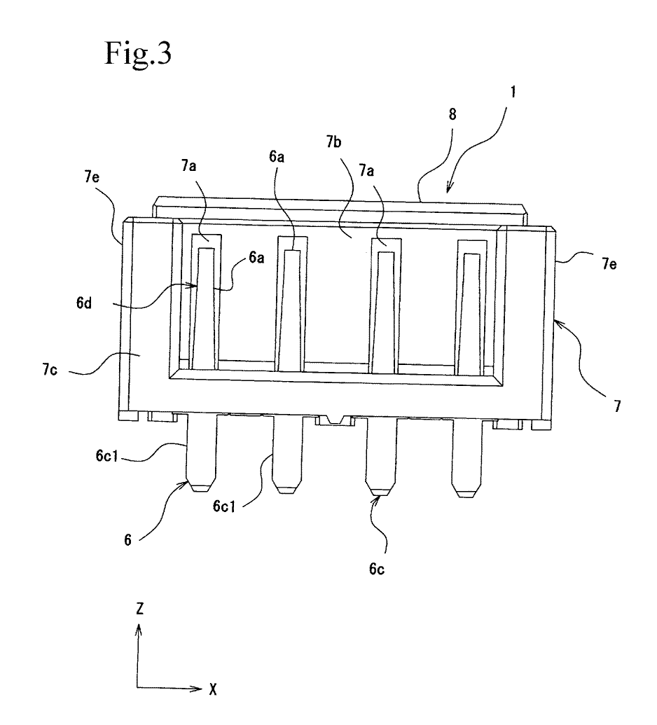

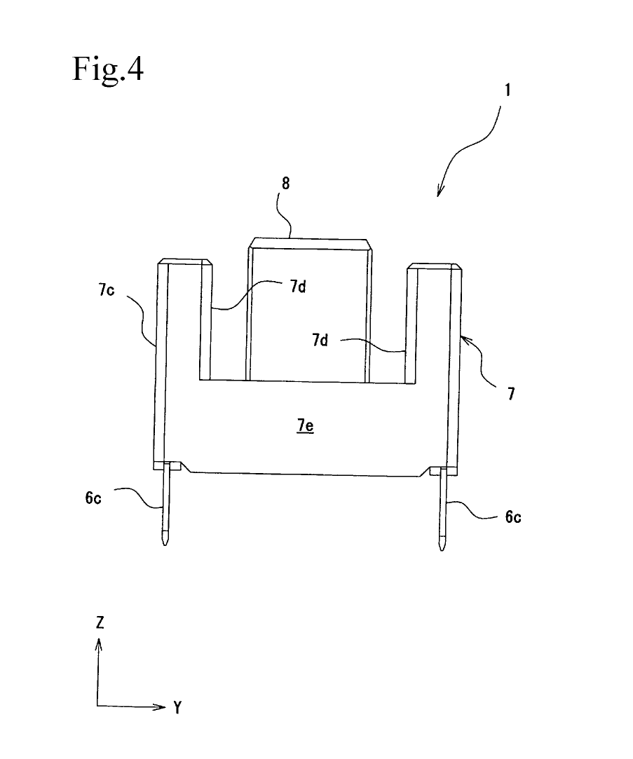

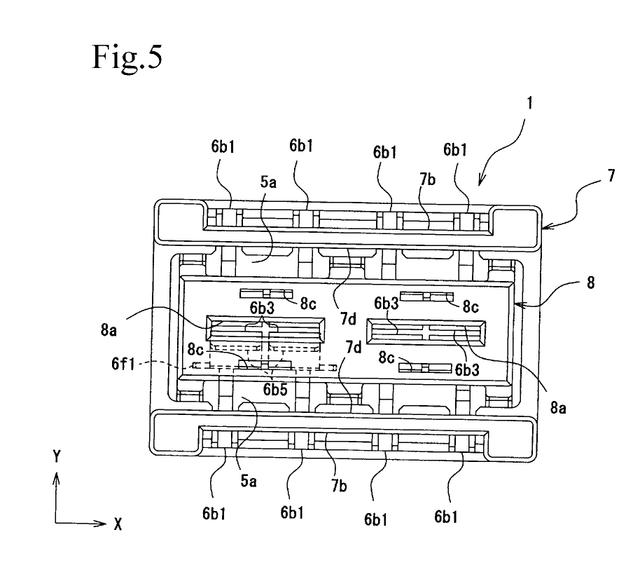

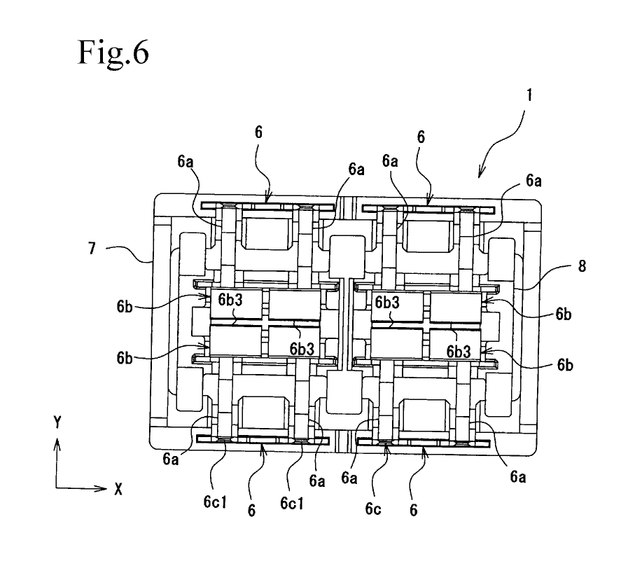

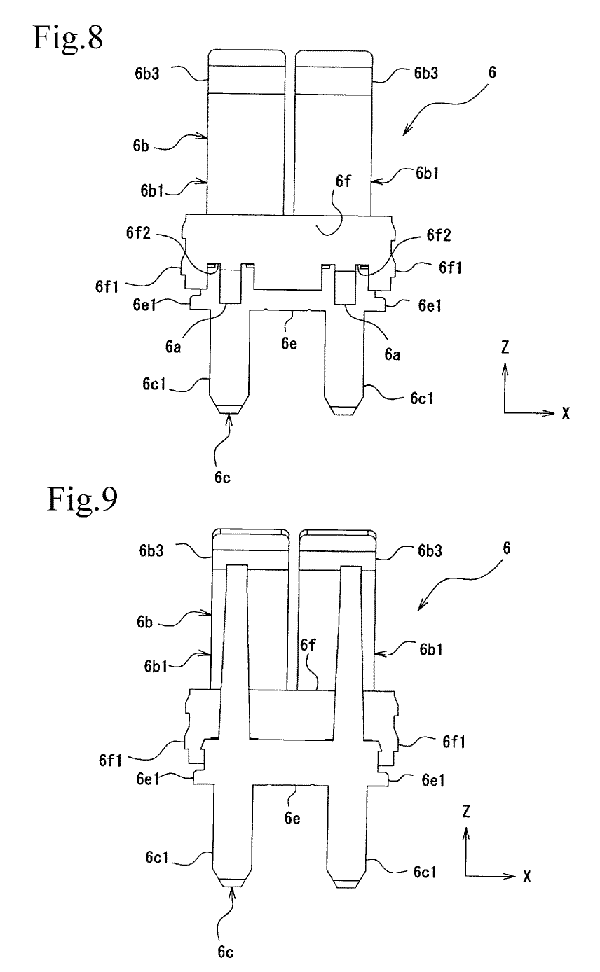

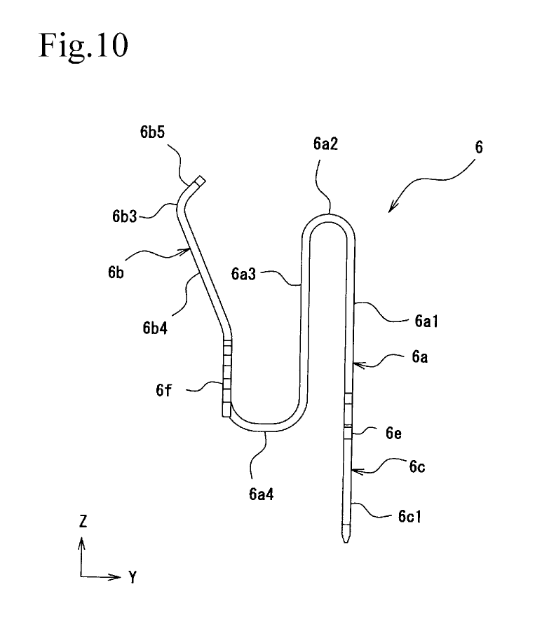

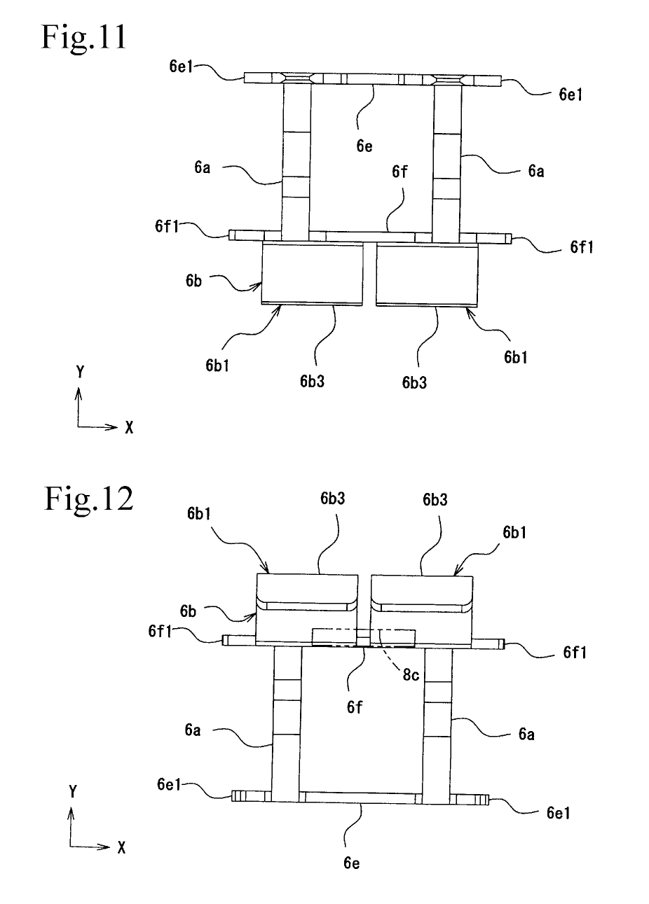

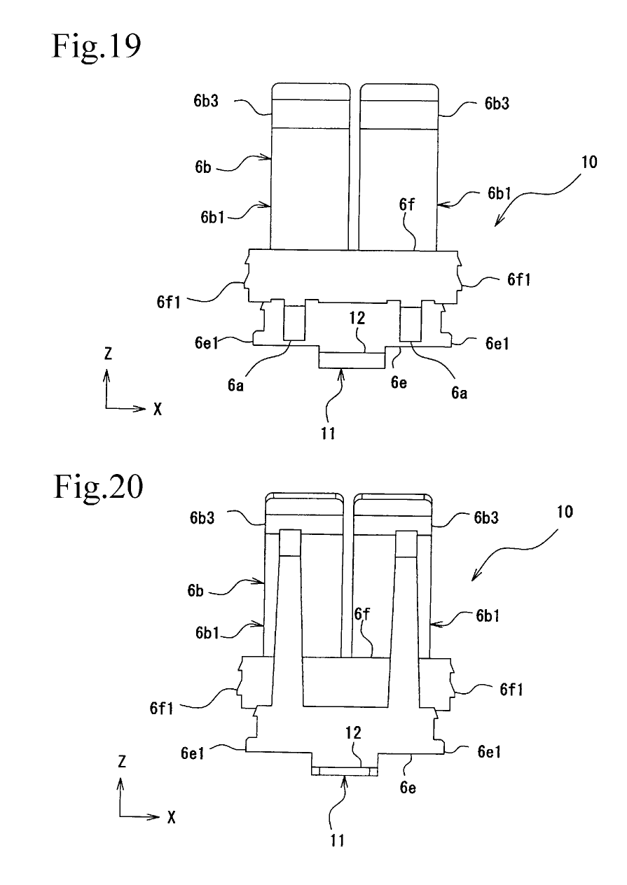

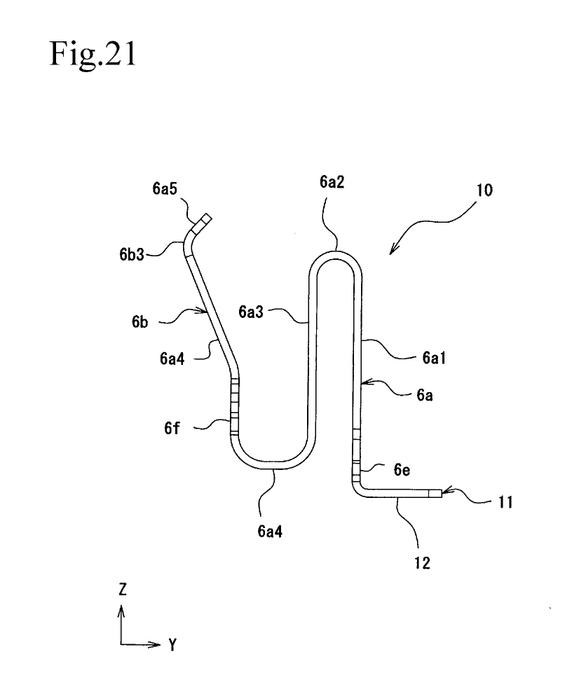

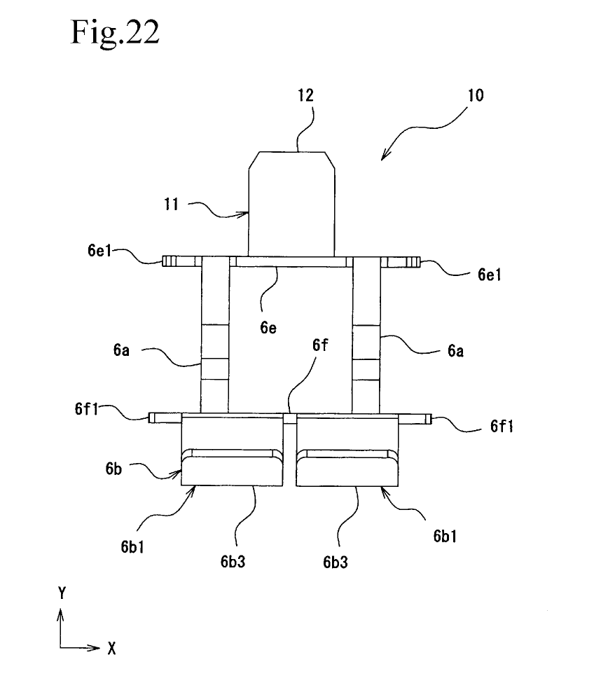

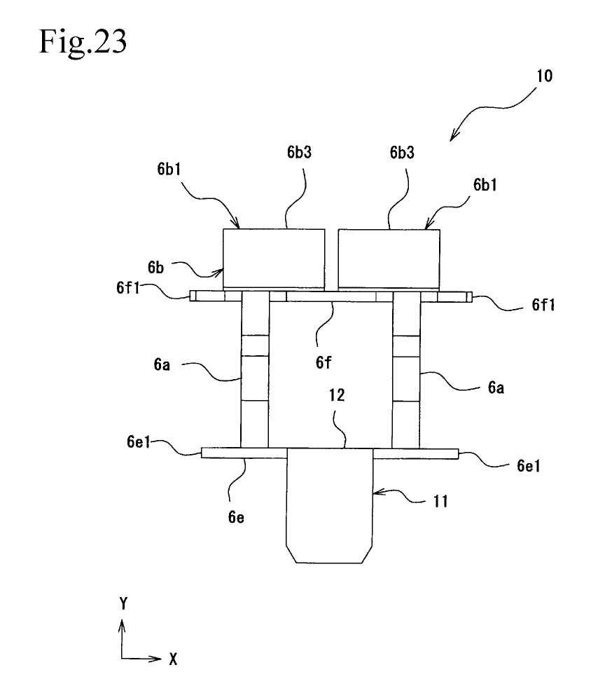

In the present description, claims, and drawings, description will be given while an X direction is a width direction extending in a longitudinal direction of socket connectors 1 and 9 illustrated in FIGS. 1 to 23, a Y direction is a front-rear direction extending in a short direction, and a Z direction is a height direction of the socket connector 1. In the height direction Z, an “upper side” is a flat surface side of each of the socket connectors 1 and 9 and a “lower side” is a bottom surface side of each of the socket connectors 1 and 9. Note that the directions such as up-down, left-right, and front-rear in the description do not limit the direction in which the connector of the present invention is used.

Note that since a front view and a rear view of each of the socket connectors 1 and 9 are depicted in a similar manner, rear views thereof are omitted. Furthermore, since a right side view and a left side view of each of the socket connectors 1 and 9 and socket terminals 6 and 10 will be depicted in a left-right symmetrical manner, the left side view thereof are omitted.

### First Embodiment [FIGS. 1 to 16]

The socket connector 1 serving as a “connector” of the present embodiment is mounted on a first substrate 2 and conductively connects the first substrate 2 and a second substrate 3, which is provided parallel to the first substrate 2, to each other. The socket connector 1 conductively connects the first substrate 2 and the second substrate 3 to each other by being fitted to a plug connector 4 fixed to the second substrate 3.

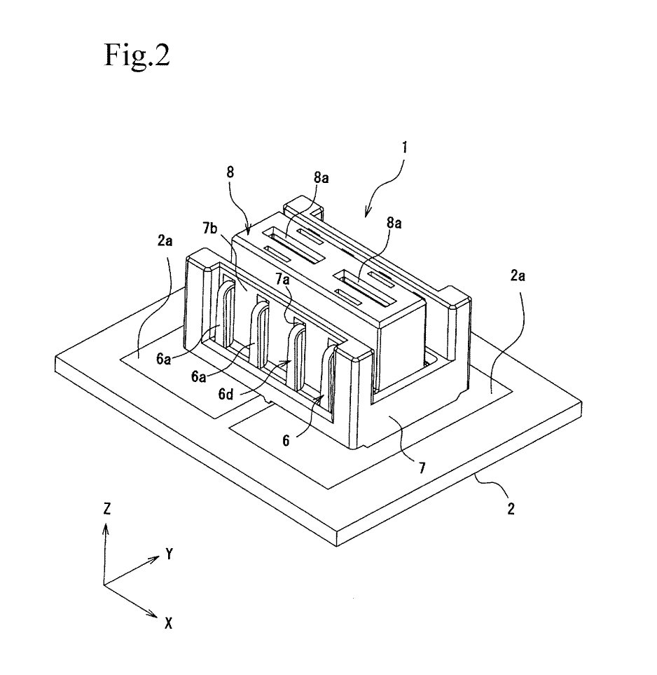

The socket connector 1 includes a housing 5 mounted on the first substrate 2, and a plurality of socket terminals 6 held by the housing 5. Four socket terminals 6 are provided in the present embodiment. The socket terminals 6 are each of a dual inline package (DIP) type and is installed in connection pads 2a and 2a (FIG. 2) provided in a circuit pattern of the first substrate 2.

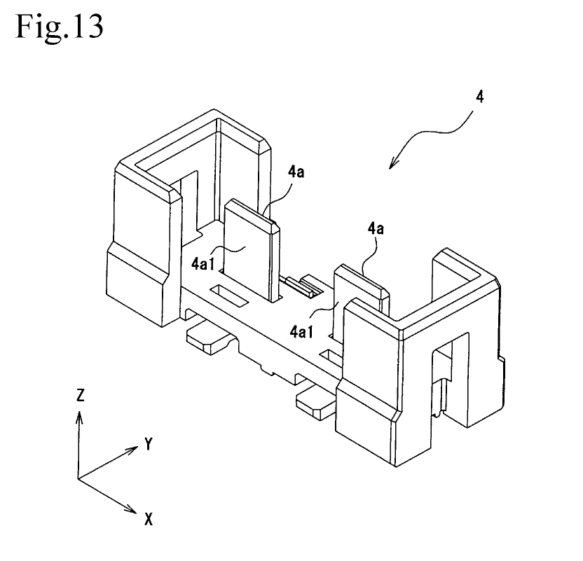

On the other hand, as illustrated in FIGS. 13 to 15, the plug connector 4 includes plug terminals 4a that each serve as a “connection object”, and is mounted on the surface of the second substrate 3. Two plug terminals 4a are provided in the present embodiment.

[Housing]

The housing 5 is formed of insulating resin, and as illustrated in FIGS. 1 to 6, includes a fixed housing 7 and a movable housing 8.

The fixed housing 7 includes side walls 7c that extend in a width direction X of the socket connector 1, side walls 7e that extend in a front-rear direction Y of the socket connector 1, inner walls 7d each provided in a surface of the corresponding side wall 7c and that faces the movable housing 8, opening portions 7b each provided on the other surface side of the corresponding side wall 7c in a recessed manner, and movable holes 7a penetrating the side walls 7c and the open in the opening portions 7b.

The side walls 7c are each provided on the two end sides of the fixed housing 7 in the front-rear direction Y. Furthermore, the side walls 7e are each provided on the two end sides of the fixed housing 7 in the width direction X. Furthermore, a movable space 5a described later is formed between each side wall 7c and the movable housing 8 such that the movable housing 8 can relatively move with respect to the fixed housing 7.

The movable holes 7a are provided so as to penetrate through the side walls 7c in the front-rear direction Y and are formed in a substantially rectangular shape elongated in a height direction Z. Branched pieces 6a of the socket terminals 6 are each inserted into the corresponding one of the movable holes 7a.

The opening portions 7b are formed in a recessed manner in the surfaces of the side walls 7c that is on the opposite side with respect to the inner walls 7d and is in communication with the movable holes 7a. Portions of the branched pieces 6a are externally exposed from the opening portions 7b.

The movable housing 8 is formed in a substantially rectangular parallelepiped shape and includes terminal insertion holes 8a into which the plug terminals 4a of the plug connector 4 are inserted, and an accommodation portion 8b that is in communication with the terminal insertion holes 8a and that accommodates contact portions 6b of the socket terminals 6. In the movable housing 8, heat releasing holes 8c are provided on both sides of each of the terminal insertion holes 8a. A distal end 6b5 of the contact portion 6b of each socket terminal 6 is provided adjacent to a corresponding heat releasing hole 8c such that the built up heat of the socket terminal 6 is discharged to the outside of the movable housing 8 from the distal end 6b5 side.

[Socket Terminal]

The socket terminal 6 is formed of a conducive metal plate and is formed by pressing. Furthermore, four socket terminals 6 are provided in the housing 5, and the four socket terminals 6 all have the same shape and size. As described above, by having a plurality of socket terminals 6 having the same shape and size, no portions of the socket terminals 6 will be connected to each other; accordingly, compared with, for example, a terminal that is formed by bending a single metal piece and that has a plurality of contact portions, the structure is simple and manufacture thereof is facilitated, and, further, electric current can be split to each of the socket terminals 6 in a reliable manner.

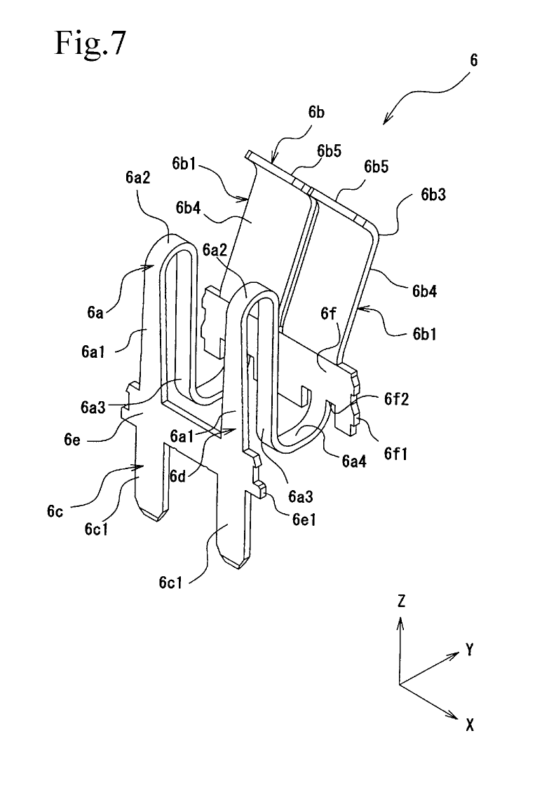

As illustrated in FIGS. 7 to 12, each socket terminal 6 includes a substrate connection portion 6c fixed to the connection pad 2a, the contact portion 6b that is brought into conductive contact with the plug connector 4, and a connection piece portion 6d that connects the contact portion 6b and the substrate connection portion 6c to each other. A Corson alloy, for example, is used as the conductive metal described above so that the socket terminal 6 can be adapted to large electric current and is high in conductivity, excellent in resisting heat, and superior in thermal deformation.

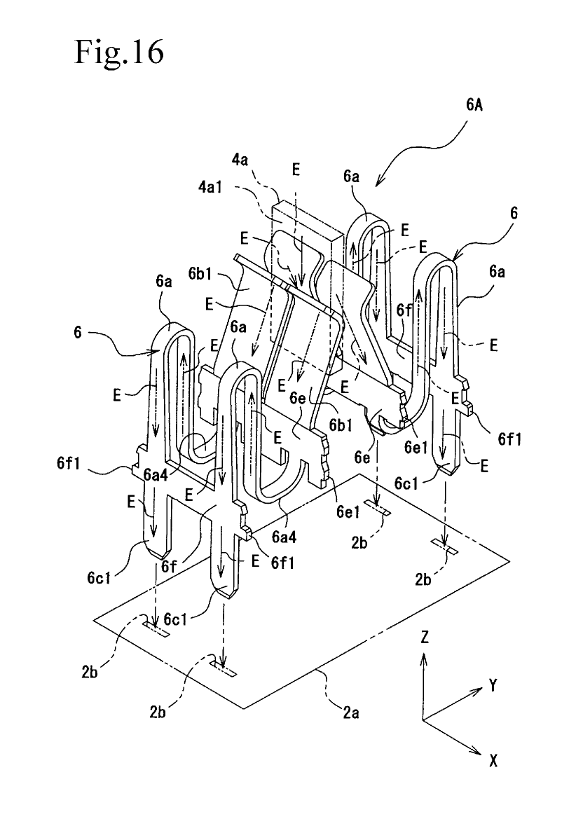

The substrate connection portion 6c includes two substrate side branch connection pieces 6c1 that are provided on one end side of the socket terminal 6 and that, as illustrated in FIG. 16, form parallel conductive paths E. Each of the substrate side branch connection pieces 6c1 are formed to have the same shape and size with respect each other. Each socket terminal 6 includes two substrate side branch connection pieces 6c1, and the substrate side branch connection pieces 6c1 are inserted into through-holes 2b provided in the first substrate 2 and are soldered thereto (not shown). With the above, the socket terminals 6 amounted on the first substrate 2.

The connection piece portion 6d includes two branched pieces 6a and forms a plurality of conductive paths E and E that connect the contact portion 6b and the substrate connection portion 6c in a parallel manner illustrated in FIG. 16. The branched pieces 6a are formed to have the same shape and size with respect each other.

Each branched piece 6a includes first vertical piece portions 6a1 serving as “elongation portions” that are elongated towards the upper side in the height direction Z of the socket connector 1 from the substrate connection portion 6c side, inversed U-shaped portions 6a2 serving as “bent portions” that are elongated from the upper ends of the first vertical piece portions 6a1 and that are bent back in an inversed U-shape, second vertical piece portions 6a3 that are elongated towards the lower side in the height direction Z from the end portions of the inversed U-shaped portions 6a2, and horizontal piece portions 6a4 that are elongated towards the contact portion 6b side in the front-rear direction Y of the socket connector 1 from the lower ends of the second vertical piece portions 6a3. The horizontal piece portions 6a4 are connected so as to extend into insides of recessed portions 6f2 open downwards that are provided in a lower edge of a first connection portion 6f. With the above, a spring length of each branched piece 6a can be made long such that the branched piece 6a can be elastically deformed in a flexible manner. Furthermore, if the horizontal piece portions 6a4 are connected to the lower edge of the first connection portion 6f without providing the recessed portions 6f2, the height positions of the horizontal piece portions 6a4 becomes lower and, as a result, the height of the branched pieces 6a becomes higher and the total height of the socket connector 1 becomes disadvantageously high. However, by forming the recessed portions 6f2, the height positions of the horizontal piece portions 6a4 can overlap the height position of the first connection portion 6f; accordingly, the entire heights of the branched pieces 6a and the socket connector 1 can be made shorter.

The first vertical piece portions 6a1 are each formed such that the width thereof becomes wider from an upper side (an inversed U-shaped portions 6a2 side) towards a lower side (a branch substrate connection portion 6c1 side), and the upper end sides of the first vertical piece portions 6a1, the inversed U-shaped portions 6a2, the second vertical piece portions 6a3, and the horizontal piece portions 6a4 are formed such that the plate widths thereof are substantially the same. For example, when fitting the socket connector 1 and the plug connector 4 to each other, if there is positional displacement therebetween or a vibration is applied to the socket connector 1, pressure will be applied to the socket terminals 6 from the plug terminals 4a. In such a case, in the socket terminals 6, there will be a load on the substrate side branch connection pieces 6c1 fixed to the connection pads 2a and on the branched pieces 6a connected to the substrate side branch connection pieces 6c1. Accordingly, by forming the first vertical piece portions 6a1 so that the side on the substrate side branch connection pieces 6c1 is wider than the side on the inversed U-shaped portions 6a2, the branched pieces 6a, to where the largest load is applied, can be made difficult to become damaged or deformed.

The end portions of the two branched pieces 6a included in a single socket terminal 6 on the side in which the substrate connection portion 6c is provided are connected to a second connection portion 6e.

Each contact portion 6b in the socket terminal 6 is provided on the other end side that is opposite the one end side in which the substrate connection portion 6c is provided and, as illustrated in FIG. 16, includes branch contact portions 6b1 and 6b1 that form the parallel conductive paths E and E. Each socket terminal 6 is formed to have the same shape and size with respect each other, and each socket terminal 6 includes two branch contact portions 6b1. The two branch contact portions 6b1 included in a single socket terminal 6 are brought into conductive contact with a single plug terminal 4a. Furthermore, each of the branch contact portions 6b1 and 6b1 is connected, on the other end side, to the connection piece portion 6d, and each of the branch contact portions 6b1 and 6b1 is connected on the connection piece portion 6d side through the first connection portion 6f.

Furthermore, each branch contact portion 6b1 includes a tabular plate surface extending in the width direction X and includes an elastic piece portion 6b4 that is inclined and elongated from the position where the branch contact portion 6b1 is connected to the connection piece portion 6d towards the upper side in a direction (a direction of contact with the plug terminal 4a when in a state in which the socket connector 1 and the plug connector 4 are fitted to each other) extending away from the connection piece portion 6d so as to be formed in a cantilevered manner. Each branch contact portion 6b1 includes a bent portion 6b3 at a height position that is substantially the same as that of the upper end portion of the connection piece portion 6d and that is on the distal end side of the elastic piece portion 6b4. Furthermore, a distal end portion 6b5 that is inclined and elongated in a direction that extends towards the upper side and that approaches the connection piece portion 6d (in a direction extending away from the plug terminal 4a when in the fitted state described above) is included in a portion from the bent portion 6b3 to the distal end side. Each bent portion 6b3 includes a contact portion 6b2 that is brought into conductive contact with the plug terminal 4a.

[Description of Structure of Connector]

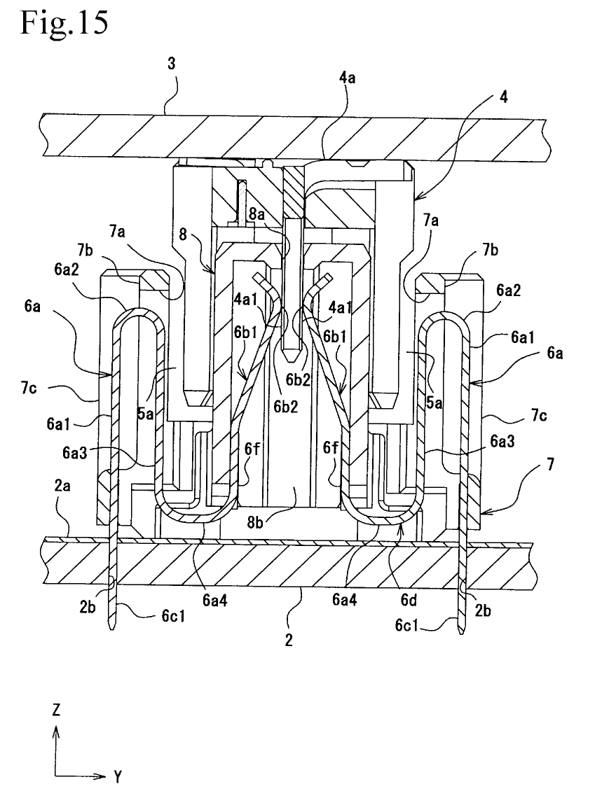

As illustrated in FIGS. 15 and 16, a pair of terminal pair 6A are formed by disposing the socket terminals 6 in a parallel manner while in a state in which the contact portions 6b2 and 6b2 are facing each other in the front-rear direction Y. Furthermore, two terminal pairs 6A are provided in the housing 5 in a parallel manner in the width direction X.

First fixing portions 6f1 and 6f1 having a protruded shape are formed in the two end side in the width direction X of the first connection portion 6f that connects the two branched pieces 6a to each other. Each socket terminal 6 is fixed to the movable housing 8 by having the first fixing portions 6f1 be engaged with first fixing reception portions (not shown) of the movable housing 8. Furthermore, second fixing portions 6e1 having a protruded shape are provided on the two end sides in the width direction X of the second connection portion 6e, which connects the branch contact portions 6b1 to each other on the substrate connection portion 6c side. Each socket terminal 6 can be fixed to the fixed housing 7 by engaging the second fixing portions 6e1 to second fixing reception portions (not shown) of the fixed housing 7. Since the branched pieces 6a included in the connection piece portion 6d and positioned between the first connection portion 6f and the second connection portion 6e are capable of elastically deforming itself as “movable pieces”, the branched pieces 6a can support the movable housing 8 in a relatively displaceable manner with respect to the fixed housing 7.

The first vertical piece portions 6a1 and the inversed U-shaped portions 6a2 of the branched pieces 6a are exposed to the outside from the opening portions 7b of the fixed housing 7, and the second vertical piece portions 6a3 are disposed inside the movable holes 7a of the fixed housing 7. Since the movable holes 7a penetrate through the side walls 7c of the fixed housing 7 in the front the front rear direction Y, the second vertical piece portions 6a3 are disposed to the outside as well.

[Description of Method of Fitting Socket Connector and Plug Connector to Each Other]

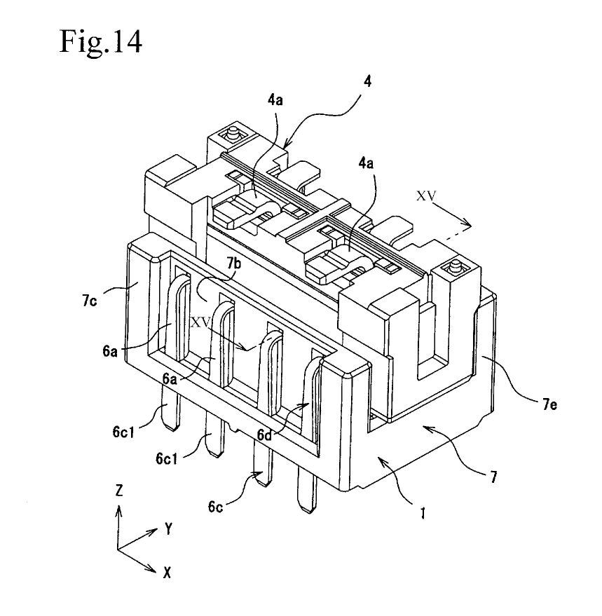

A state fitted to the socket connector 1 is illustrated in FIGS. 14 and 15. In a case in which the socket connector 1 and the plug connector 4 are fitted to each other, the plug terminals 4a are first inserted into the terminal insertion holes 8a provided in the upper surface of the movable housing 8. The plug terminals 4a are further inserted into the accommodation portion 8b of the movable housing 8, and the distal ends of the plug terminals 4a are inserted between the contact portions 6b and 6b of the socket terminals 6 and 6 forming the terminal pairs 6A. Subsequently, the plug terminals 4a push and widen the portions between the contact portions 6b and 6b and are inserted between the contact portions 6b2 and 6b2.

Subsequently, by inserting the plug terminals 4a deep into the accommodation portion 8b, the contact surfaces 4a1 of the plug terminals 4a and the contact portions 6b2 and 6b2 of the socket terminals 6 are brought into conductive contact with each other such that the plug terminals 4a and the socket terminals 6 become conductively connected to each other. Fitting of the socket connector 1 and the plug connector 4 to each other is completed in the above manner.

[Description of Electric Current Splitting Effect of Socket Connector]

A circuit pattern formed of copper foil is provided on the first substrate 2, and as illustrated in FIGS. 2 and 16, the connection pads 2a and 2a are provided for connecting the socket terminals 6. The socket connector 1 includes two pairs of terminal pairs 6A (four mutually independent socket terminals 6). A pair of terminal pair 6A (the socket terminals 6 and 6) among the two pairs of terminal pairs 6A are connected to a single and common connection pad 2a (FIG. 16). Accordingly, an electric current flowing into the socket connector 1 through a single plug terminal 4a can be split to the two socket terminals 6 and 6 in a parallel manner and connection can be made to a single and common connection pad 2a; accordingly, the resistance value can be lowered. Accordingly, the socket connector 1 can be one in which management of a large electric current is facilitated.

The plug connector 4 includes the two plug terminals 4a and 4a that are independent of each other, and an electric current flows into the plug terminals 4a and 4a through the two paths formed in the substrate 3.

The contact portion 6b of one of the socket terminals 6 and the contact portion 6b of the other one of the socket terminals 6 that form a terminal pair 6A come into conductive contact with a single plug terminal 4a.

Specifically, as illustrated in FIG. 16, the two branch contact portions 6b1 of each of the contact portions 6b of the one and the other one of the socket terminals 6 that oppose each other hold the plug terminal 4a in between so as to establish a conductive contact. In so doing, even if the terminal surfaces 4a1 of the plug terminals 4a come in contact with the branch contact portions 6b1 in an inclined manner or even if there is unevenness on the terminal surfaces 4a1 of the plug terminals 4a, since the opposing socket terminals 6 are formed independently and the branch contact portions 6b1 and 6b1 elastically deform independently, the branch contact portions 6b1 of each of the terminals 6 can follow the terminal surface 4a1 of the corresponding plug terminal 4a. Accordingly, contact with the plug terminals 4a can be maintained in a reliable manner.

In the above manner, in the socket connector 1, the electrical current from a single plug terminal 4a is split to the two socket terminals 6 in a parallel manner and, further, is split into two branch contact portions 6b1 in each of the socket terminals 6 in a parallel manner; accordingly, the resistance value can be lowered. Accordingly, the connector can be one in which management of a larger electric current is facilitated.

Since the electric current that has passed through the branch contact portions 6b1 and 6b1 is, then, split to the two branched pieces 6a and 6a in a parallel manner, the resistance value of the connection piece portion 6d can be lowered. Accordingly, similar to the above, the socket connector 1 can be one in which management of a larger electric current is facilitated.

Since the electric current that has passed through the branched pieces 6a and 6a is, then, split to the two substrate side branch connection pieces 6c1 and 6c1 in a parallel manner, the resistance value of the entire substrate connection portion 6c can be lowered. Accordingly, the socket connector 1 can be one in which management of a larger electric current is facilitated.

Furthermore, since each socket terminal 6 includes two substrate side connection pieces 6c1, a terminal pair 6A includes four substrate side connection pieces 6c1 in total. A plurality of through-holes 2b are formed in the connection pads 2a, and by inserting the substrate side connection pieces 6c1 of the socket terminals 6 therein and by performing soldering, the socket terminals 6 is fixed to the substrate 2.

The through-holes 2b and 2b are provided in a single and common connection pad 2a, and each of the substrate side branch connection pieces 6c1 and 6c1 are inserted into a different one of the through-holes 2b and 2b and are fixed. Accordingly, the two socket terminals 6 included in a pair of terminal pair 6A can be conductively connected to a single connection pad 2a.

Each substrate side branch connection piece 6c1 and the first vertical piece portion 6a1 of the corresponding branched piece 6a of the present embodiment are each formed into a plate-like piece and are disposed on a single linear axis extending in the height direction Z. By doing so, compared with a case in which the substrate side branch connection piece 6c1 and the first vertical piece portion 6a1 are provided on different axes or in which the substrate side branch connection piece 6c1 and the first vertical piece portion 6a1 are formed in a curved manner, the conductive paths E can be formed in the short and straight manner; accordingly, the resistance value can be lowered. Furthermore, even in a case described later in which a floating mechanism is actuated and the branched pieces 6a are deformed, the load can be distributed to the entire substrate side branch connection pieces 6c1 and first vertical piece portions 6a1 in a uniform manner. Accordingly, damage and the like of the socket terminals 6 can be made to not easily occur.

[Description of Movable Mechanism]

The floating mechanism in the front-rear direction Y provided in the socket connector 1 will be described first. The movable spaces 5a are provided between the movable housing 8 and the side walls 7c extending in the width direction X of the fixed housing 7, and, in the movable spaces 5a, the movable housing 8 can be relatively displaced in the front-rear direction Y with respect to the fixed housing 7. Furthermore, the horizontal piece portion 6a4 is provided in the branched piece 6a of each connection piece portion 6d in the socket terminal 6. Since each horizontal piece portion 6a4 is provided so as to be connected to the corresponding first fixing portion 6f1 fixed to the movable housing 8, the corresponding branched piece 6a of the socket terminal 6 elastically deforms in accordance with the movement of the movable housing 8. Specifically, since each horizontal piece portion 6a4 is connected to the lower end of the corresponding second vertical piece portion 6a3, the second vertical piece portion 6a3 elastically deforms as well in accordance with the movement of the horizontal piece portion 6a4. Furthermore, upon elastic deformation of the U-shaped portions 6a2 and the first vertical piece portions 6a1 in accordance with the above, the entire branched pieces 6a elastically deform. The movable housing 8 can be displaced in the front-rear direction Y with respect to the fixed housing 7 in the above manner.

As described above, when the plug connector 4 is fitted to the socket connector 1, there may be a case in which the plug connector 4 and the socket connector 1 are positionally displaced with respect each other. Furthermore, vibration may be applied to the socket connector 1 in the fitted state. In such a case, as described above, the branched pieces 6a of the socket terminals 6 become elastically deformed and the movable housing 8 becomes displaced with respect to the fixed housing 7; accordingly, positional displacement and vibration of the socket connector 1 can be absorbed.

While the floating mechanism described above absorbs the positional displacement and the vibration in the front-rear direction Y of the socket connector 1, positional displacement and the vibration in the width direction X and in the height direction Z can be absorbed in a similar manner with sliding contact between the socket terminals 6 and the plug terminals 4a. In other words, when positional displacement and vibration occur in the width direction X, while in sliding contact with each other, the contact portions 6b and the plug terminals 4a are relatively displaced with respect each other in the width direction X. Furthermore, the contact portions 6b and the plug terminals 4a are relatively displaced with respect each other while in sliding contact with each other in the height direction Z as well. If floating mechanisms for the width direction X and the height direction Z are to be provided as well, movable pieces that are capable of elastic deformation in the respective directions need to be provided and, in some cases, the socket connector 1 may need to be increased in size. However, as is the case of the socket connector 1 of the present embodiment, by having sliding contact be performed for the width direction X and the height direction Z, positional displacement during fitting and vibration while in a fitted state can be absorbed without increasing the size of the socket connector 1.

[Description of Heat Generation Suppressing Effect of Socket Connector]

When conductively connecting to a mating terminal to which a large electric current is distributed through contact of a single terminal, heat is generated due to increase in the resistance value; accordingly, there may be disadvantageous cases in which the housing is melted or the terminal is thermally cut by the heat. In order to prevent such a situation, the entire socket terminal 6 needs to be increased in size in order to reduce the resistance value of the socket terminal 6. However, with a connector provided with a terminal with increased size, it is difficult to respond to the demand of recent years to miniaturize the connectors.

On the other hand, as described above, in the socket connector 1 of the present embodiment, by providing a plurality of socket terminals 6, the electric current can be split and, furthermore, a plurality of conductive paths E that split the electric current in a parallel manner in each of the socket terminals 6 are formed. By so doing, conductive connection can be established after the electric current has been split at multiple stages in a single socket connector 1; accordingly, it will be possible to correspond to a large electric current while reducing size. Since the socket terminals 6 are formed so as to have the same shape and size and the electric current values flowing through the socket terminals 6 can be equalized, the connector can be one in which management of a larger electric current is facilitated.

As described above, by forming parallel conductive paths E in the branch contact portions 6b1 and splitting the electric current in a parallel manner, the resistance value can be lowered and the socket connector 1 can be one in which management of a higher electric current is facilitated. Furthermore, even in a case in which, for example, the cross-sectional area of the two branch contact portions 6b1 included in a single socket terminal 6 is formed smaller than those of the other portions of the socket terminal 6, by forming a plurality of parallel conductive paths E in the above manner, heat generation from the branch contact portions 6b1 can be suppressed.

Furthermore, by having the cross-sectional area of the branch contact portions 6b1 included in a single socket terminal 6 be the same and, for example, by forming the branch contact portions 6b1 to have the same shape and size, the values of the electric current flowing in the branch contact portions 6b1 can be equalized. Accordingly, the heat quantities of the branch contact portions 6b1 can be equalized by equalizing the resistance value such that a situation in which one of the branch contact portions 6b1 alone becomes high in temperature can be prevented.

As described above, by forming parallel conductive paths E in the branched pieces 6a and splitting the electric current in a parallel manner, the resistance value can be lowered and the socket connector 1 can be one in which management of a higher electric current is facilitated. Furthermore, even in a case in which, for example, the cross-sectional area of the two branched pieces 6a included in a single socket terminal 6 is formed smaller than those of the other portions of the socket terminal 6, heat generation from the branched pieces 6a can be suppressed.

By having the cross-sectional area of the branched pieces 6a included in a single socket terminal 6 be the same and, for example, by forming the branched pieces 6a to have the same shape and size, the values of the electric current flowing in the branched pieces 6a can be equalized. Accordingly, the heat quantities of the branched pieces 6a can be equalized by equalizing the resistance value such that a situation in which one of the branched pieces 6a alone becomes high in temperature can be prevented.

As described above, the socket connector 1 includes the floating mechanism. In such a connector, typically, it is desirable that a movable piece of a single terminal is formed thin and narrow in a thin shaft shape in order to facilitate elastic deformation in a flexible manner. However, when the movable piece is formed thin and narrow in width, the cross-sectional area thereof becomes smaller and the electric resistance becomes larger. In such a case, when a large electric current is distributed, the movable piece generating heat becomes high in temperature and becomes burnt black, or in the worst case scenario, may become thermally cut. Conversely, when the cross-sectional area of the movable piece is increased to suppress heat generation, elastic deformation described above will be difficult and, further, it will be difficult to respond to the demand in miniaturization of the collector. Accordingly, when focusing on the movable piece, it will be difficult to achieve both flexibility in the floating mechanism and responding to a large electric current.

Accordingly, different from the conventional terminal in which a single movable piece is provided in a single terminal, in the socket connector 1 of the present embodiment, branched pieces 6a included in the connection piece portion 6d are configured as movable pieces such that heat generation is suppressed while both increase in the cross-sectional area so as to be capable of being used under a large electric current and flexibility of the movable pieces to manage the floating mechanism are achieved.

Furthermore, by having the branched pieces 6a to have a narrow width, a wider space can be provided between the two branched pieces 6a. Accordingly, a structure in which release of heat is further facilitated is obtained.

Note that the width of the space for releasing heat is desirably a width in which at least about one branched piece 6a can be disposed between the branched pieces 6a and 6a and parallel to the branched pieces 6a and 6a.

The movable holes 7a and the opening portions 7b that penetrate the side walls 7c are formed in the fixed housing 7 of the socket connector 1, and the branched pieces 6a are exposed to the outside through the movable holes 7a and the opening portions 7b. By so doing, release of heat generated in the branched pieces 6a to the outside is facilitated such that heat release is facilitated.

As described above, by forming the parallel conductive paths E and E in the two substrate side branch connection pieces 6c1 included in a single socket terminal 6 and splitting the electric current in a parallel manner, the resistance value can be lowered and the socket connector 1 can be one in which management of a higher electric current is facilitated. Furthermore, by so doing, even in a case in which, for example, the cross-sectional area of the substrate side branch connection pieces 6c1 is formed smaller than those of the other portions of the socket terminal 6, heat generation from the substrate side branch connection pieces 6c1 can be suppressed.

By having the cross-sectional areas of the two substrate side branch connection pieces 6c1 included in a single socket terminal 6 be the same and, for example, by forming the substrate side branch connection pieces 6c1 to have the same shape and size, the values of the electric current flowing in the substrate side branch connection pieces 6c1 can be equalized. Accordingly, the heat quantities of the substrate side branch connection pieces 6c1 can be equalized by equalizing the resistance value such that a situation in which one of the substrate side branch connection pieces 6c1 alone becomes high in temperature can be prevented.

By providing a wider space between the two substrate side branch connection pieces 6c1, it will be possible to obtain a structure in which release of heat is further facilitated.

Note that the width of the space for releasing such a heat is desirably a width in which at least about one substrate side branch connection piece 6c1 can be disposed in parallel between the substrate side branch connection pieces 6c1 and 6c1.

A case in which the increase in temperature of the socket terminals 6 during conductive contact with the plug terminals 4a is suppressed to 30 K or under while the maximum rated current is 15 A will be exemplified to describe the performance of the socket terminals 6 of the present embodiment in detail. Since each socket terminal 6 includes two branch contact portions 6b1, a single terminal pair 6A includes four branch contact portions 6b1. Furthermore, a total of four contact portions 6b2 included in the branch contact portions 6b1 are conductively connected to the plug terminal 4a. As described above, by coming in contact with the plug terminal 4a at four points, even if the electric current value is increased to about 28.0 A, the increase in temperature can be suppressed to 30 K or under. Furthermore, even if one of the four contact portions 6b2 is separated from the plug terminal 4a and the contact with the terminal pairs 6A is at three points, the increase in temperature can be suppressed to 30 K or under even if the electric current value is increased to about 23.0 A. Accordingly, the requirement of a maximum rated current of 15 A can be sufficiently met with some margin. Furthermore, even if the contact between the plug terminal 4a and the contact portions 6b2 is at two points, the increase in temperature can be suppressed to 30 K or under even if the electric current value is increased to about 17.5 A.

Accordingly, even if by any chance about two contact portions 6b2 of the socket terminals 6 in the terminal pair 6A are separated from the plug terminal 4a, the requirement of the maximum rated current of 15 A can be met sufficiently.

As described above, in the socket connector 1 of the present embodiment, the electric current can be split by forming a plurality of conductive paths E; accordingly, it will be possible to correspond to a large electric current while reducing size.

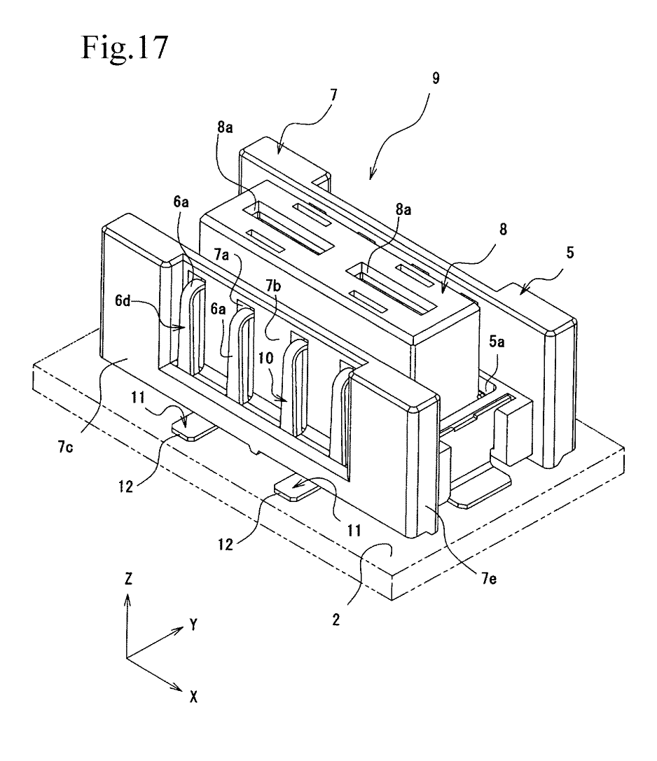

### Second Embodiment [FIGS. 17 to 23]

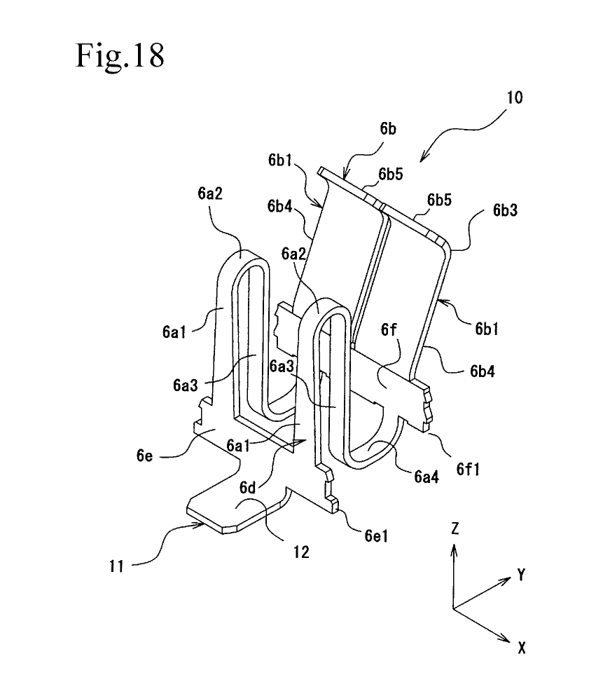

A DIP type socket connector has been exemplified as the socket connector 1 of the first embodiment described above. Conversely, as illustrate in FIG. 17, a socket connector 9 that is a surface mounting type mounted on the substrate 2 can be used. In such a case, socket terminals 10 included in the socket connector 9 include, as illustrated in FIGS. 18 to 23, substrate connection portions 11 including soldering portions 12 that are bent and elongated parallel to the substrate 2 from the second connection portions 6e. Furthermore, each of the substrate connection portions 11 may not be provided with the substrate side branch connection piece 6c1 and may include a single soldering portion 12 that has a width that is suitable for soldering. The socket connector 9 enables various mounting methods to be performed according to the mounting position.

Modification:

In the embodiments described above, exemplifications of socket connectors 1 and 9 that are provided with four socket terminals 6 and 10 forming two pairs of terminal pairs 6A have been given. Conversely, for example, six or more socket terminals 6 forming three or more pairs of terminal pairs 6A may be provided. On the other hand, in a case in which the electric current value is small and there is no need to provide four socket terminals 6, the socket connector 1 may be provided with only a pair of opposing socket terminals 6. By so doing, the socket connector 1 can be made smaller.

In each of the embodiments described above, an exemplification of a socket connector 1 including two substrate side branch connection pieces 6c1 has been given; however, three or more may be provided, for example.

Furthermore, in a similar manner, in each of the embodiments described above, an exemplification of a socket connector 1 including two branched pieces 6a has been given; however, three or more may be provided. Furthermore, in a similar manner, in each of the embodiments described above, an exemplification of a socket connector 1 including two branch contact portions 6b1 has been given; however, three or more may be provided. By increasing the number of substrate side branch connection pieces 6c1, branched pieces 6a, and branch contact portions 6b1, the number of parallel conductive paths E is increased and the resistance value can be lowered; accordingly, the socket connector 1 can be one in which management of a larger electric current is facilitated without an increase in size.

By splitting the electric current in the above manner, heat generation suppressing effect of the socket terminals 6 can be increased. Furthermore, in such a case, by providing sufficient space for releasing heat between the substrate side branch connection pieces 6c1, between the branched pieces 6a, and between the branch contact portions 6b1 of a single socket terminal 6, the heat generation suppressing effect created by splitting the electric current can be increased further.

In each of the exemplary embodiments described above, an example in which the housing 5 includes a fixed housing 7 and a movable housing 8 relatively displaceable with respect to the fixed housing 7, and the connection piece portion 6d supports the movable housing 8 in a relatively displaceable manner with respect to the fixed housing 7 has been given. Conversely, in a case in which the floating mechanism is not needed, a single housing in which the fixed housing 7 and the movable housing 8 are integrally configured may be provided. In such a case, the connection piece portion 6d may be left to play a role of merely connecting the contact portions 6b and the substrate connection portions 6c to each other and splitting the electric current in a parallel manner.

In each of the embodiments described above, an exemplification of the first connection portion 6f connected to the two branch contact portions 6b1 has been given; however, the first connection portion 6f may be connected to the two branched pieces 6a. Furthermore, an exemplification of the second connection portion 6e connected to the two branched pieces 6a has been given; however, the second connection portion 6e may be connected to the two substrate side branch connection pieces 6c1.

In each of the embodiments described above, an example in which the electric current flows from the plug terminals 4a towards the socket terminals 6 has been illustrated. However, opposite to the above, the configuration may be such that the electric current flows from the socket terminals 6 towards the plug terminals 4a.

### REFERENCE SIGNS LIST

1 socket connector (first embodiment)

2 first substrate

2a connection pad

2b through-hole

3 second substrate

4 plug connector

4a plug terminal (connection object)

4a1 contact surface

5 housing

5a movable space

6 socket terminal (first embodiment)

6A terminal pair

6a branched piece

6a1 first vertical piece portion

6a2 inversed U-shaped portion

6a3 second vertical piece portion

6a4 horizontal piece portion

6b contact portion

6b1 branch contact portion

6b2 contact portion

6b3 bent portion

6b4 elastic piece portion

6b5 distal end portion

6c substrate connection portion

6c1 substrate side branch connection piece

6d connection piece portion

6e second connection portion

6e1 second fixing portion

6f first connection portion

6f1 first fixing portion

6f2 recessed portion

7 fixed housing

7a movable hole

7b opening portion

7c side wall

7d inner wall

7e side wall

8 movable housing

8a terminal insertion hole

8b accommodation portion

8c heat releasing hole

9 socket connector (second embodiment)

10 socket terminal (second embodiment)

11 substrate connection portion (second embodiment)

12 soldering portion

E conductive path

1. A connection structure of a connector, comprising:
a first connector that conductively connects a connection object to a substrate;
the first connector including
a housing, and
a plurality of terminals that hold the connection object in between and that come into contact with the connection object; and
the plurality of terminals each including
a substrate connection portion that comes into conductive contact with a common connection pad provided on the substrate,
a contact portion that comes into conductive contact with the connection object, and
a connection piece portion formed of a plurality of branched pieces connecting, in a parallel manner, each substrate connection portion and the corresponding contact portion.

2. A connector, comprising:
a housing mounted on a substrate;
a plurality of terminals held by the housing; and
each of the terminals including
a substrate connection portion that conductively connects to a common connection pad provided on the substrate,
a contact portion that comes into conductive contact with a common connection object that is a connection mate of the connector, and
a connection piece portion formed of a plurality of branched pieces forming parallel conductive paths that connect each of the substrate connection portion and the corresponding contact portion to each other.

3. The connector according to claim 2, wherein
the contact portion includes a plurality of branch contact portions that form parallel conductive paths.

4. The connector according to claim 2, wherein
the substrate connection portion includes a plurality of branch substrate connection portions that form parallel conductive paths.

5. The connector according to claim 2, wherein
the housing includes a fixed housing and a movable housing relatively displaced with respect to the fixed housing,
the substrate connection portion is provided in the fixed housing,
the contact portion is provided in the movable housing, and
the branched pieces of the connection piece portion are movable pieces that support the movable housing in a relatively displaceable manner with respect to the fixed housing.

6. The connector according to claim 2, wherein
the housing accommodates the terminals therein and includes an opening portion that exposes the connection piece portion of the terminals externally.

7. The connector according to claim 5, wherein
the movable pieces each include
an elongation portion that is elongated from the substrate connection portion, and
a bent portion bent back from an end portion of the elongation portion, and
the elongation portion is formed such that a width on a substrate connection portion side is wider than a width of the bent portion.

8. The connector according to claim 2, wherein
the plurality of terminals are disposed to oppose each other and be in conductive contact with the connection object in between.

9. The connector according to claim 2, wherein
the plurality of terminals have same shape and size.
